(19) United States
(12) Patent Application Publication
(10) Pub. No.: US 2011/0072706 A1
(43) Pub. Date: Mar. 31, 2011

(54) Insect-Shaped Fake Bait Structure and a Shaping Method Thereof

(76) Inventor: Tsung-Hsi Tsai, Changhua City (TW)

(21) Appl. No.: 12/407,466

(22) Filed: Mar. 19, 2009

(30) Foreign Application Priority Data
Feb. 13, 2009 (CN) 200920005155.9

(51) Int. Cl. A01K 85/08; A01K 85/00; A01K 99/00

(52) U.S. Cl. 43/42.27; 43/42.53

(57) ABSTRACT

The present invention relates to an insect-shaped fake bait structure and a shaping method thereof. The insect-shaped fake bait structure includes a wing made of a metallic plate. The wing is formed with a plurality of guiding holes, a plurality of line holes, a fishhook hole, and a plurality of through holes. A portion of the wing about near the plurality of through holes is formed by die casting with a metallic material through an insect-shaped mold to form an insect-shaped body. The wing is integrated with the insect-shaped body by filling a material in the plurality of through holes. When the present invention is in use, the wing will swing by the turbulent flow through the plurality of guiding holes for attracting fish to attack the insect-shaped fake bait so that a fishhook is adapted to hook fish.

### BACKGROUND OF THE INVENTION

1. Field of the Invention

The present invention relates to an insect-shaped fake bait structure and a shaping method thereof, and more particularly to a wing made of a metallic plate. The wing is formed with a plurality of guiding holes, a plurality of line holes, a fishhook hole, and a plurality of through holes. A portion of the wing about near the plurality of through holes is formed by die casting with a metallic material (such as a lead material) through an insect-shaped mold to form an insect-shaped body.The wing is integrated with the insect-shaped body by filling the lead material in the plurality of through holes. When the present invention is in use, the wing will swing by the turbulent flow through the plurality of guiding holes for attracting fish to attack the insect-shaped fake bait.

2. Description of the Prior Art

A fake fish is used as an auxiliary tool for fishing. The fake fish is provided with a plurality of fishhooks. The fake fish is brightly colored like a rear fish for attracting fish to approach the baits on the fishhooks so as to hook fish. There is not an insect-shaped fake bait for the purpose of fishing. Accordingly, the inventor of the present invention has devoted himself based on his many years of practical experiences to the development of an insect-shaped fake bait.

### SUMMARY OF THE INVENTION

According to a first aspect of the present invention, there is provided an insect-shaped fake bait structure comprising a wing made of a metallic plate, the wing being formed with a plurality of guiding holes, a plurality of line holes, a fishhook hole, and a plurality of through holes, a portion of the wing about near the plurality of through holes being formed by die casting through an insect-shaped mold to form an insect-shaped body, the wing being integrated with the insect-shaped body by filling a material in the plurality of through holes. When the present invention is in use, the wing will swing by the turbulent flow through the plurality of guiding holes for attracting fish to attack the insect-shaped fake bait so that a fishhook is adapted to hook fish.

Preferably, the wing is made of a flexible metallic plate for providing a swing effect in a turbulent flow.

Preferably, the flexible metallic plate is a copper plate.

Preferably, the insect-shaped body has a specific gravity greater than that of sea water or lake water for facilitating the insect-shaped fake bait to sink in the sea water or lake water.

According to a second aspect of the present invention, there is provided a method for shaping an insect-shaped fake bait, comprising the following steps of:

(a) stamping a flexible metallic plate to form a wing having a plurality of guiding holes, a plurality of line holes, a fishhook hole, and a plurality of through holes;

(b) inserting a portion of the wing near the plurality of through holes into an insect-shaped mold; and

(c) die-casting with a metallic material to fill the metallic material in the plurality of through holes for integrating the wing and an insect-shaped body.

### BRIEF DESCRIPTION OF THE DRAWINGS

FIG. 1 is an exploded view of the present invention;

FIG. 2 is a perspective view of the present invention;

FIG. 3 is a cross-sectional view of the present invention; and

FIG. 4 is a flowchart of a shaping method of the present invention.

### DETAILED DESCRIPTION OF THE PREFERRED EMBODIMENTS

Embodiments of the present invention will now be described, by way of example only, with reference to the accompanying drawings.

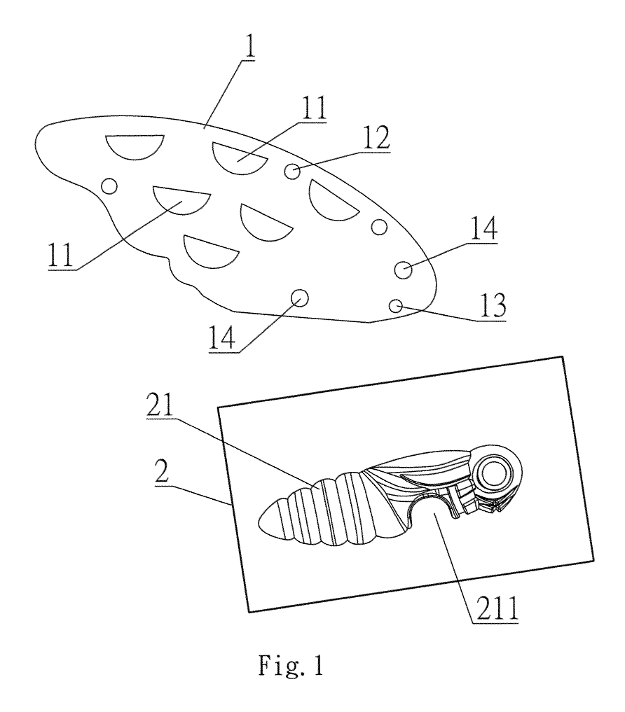

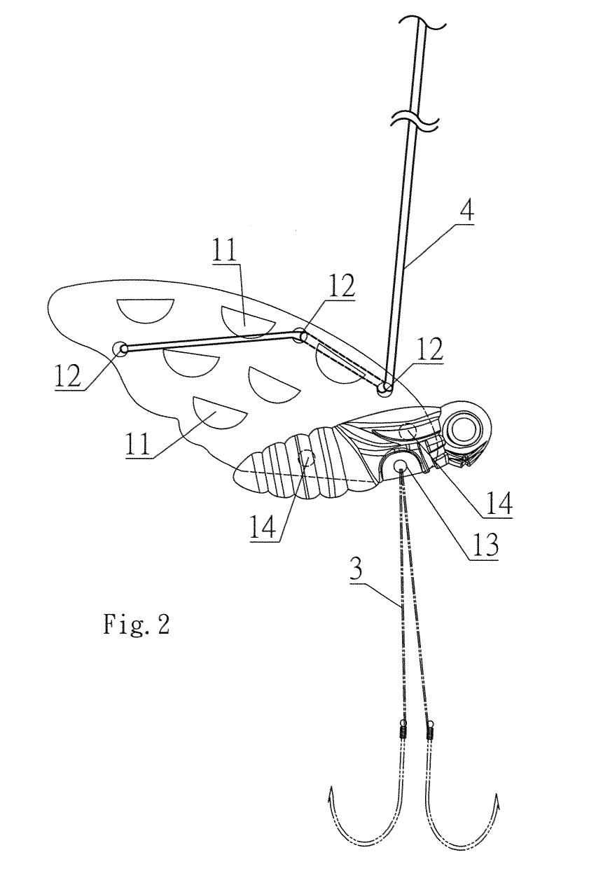

Referring to FIGS. 1 through 3, an insect-shaped fake bait structure according to a preferred embodiment of the present invention comprises a wing 1 made of a metallic plate. The wing 1 is formed with a plurality of guiding holes 11, a plurality of line holes 12, a fishhook hole 13, and a plurality of through holes 14. A portion of the wing 1 about near the plurality of through holes 14 is formed by die casting with a metallic material through an insect-shaped mold 2 to form an insect-shaped body 21. The wing 1 is integrated with the insect-shaped body 21 by filling a material in the plurality of through holes 14, as shown in FIG. 2. After die-casting, the fishhook hole 13 is exposed and corresponds in position to a notch 211 of the insect-shaped body 21 for a fishhook line 3 to be inserted therethrough. A fishing line 4 is inserted through the plurality of line holes 12 and positioned thereat. When the present invention is used in a sea or lake, the wing 1 will swing by the turbulent flow through the plurality of guiding holes 11 for attracting fish to attack the insect-shaped fake bait so that a fishhook is adapted to hook fish.

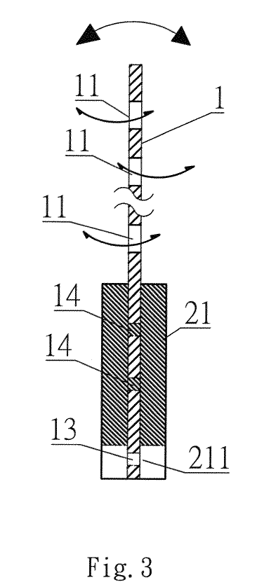

Referring to FIG. 1, the wing 1 made of a flexible metallic plate provides a swing effect in the turbulent flow, as shown in FIG. 3. Preferably, the flexible metallic plate is a copper plate.

Referring to FIG. 2, the specific gravity of the insect-shaped body 21 is greater than that of sea water or lake water. Preferably, the insect-shaped body 21 is made of a lead material and formed by die-casting, facilitating the insect-shaped fake bait to sink in the sea water or lake water.

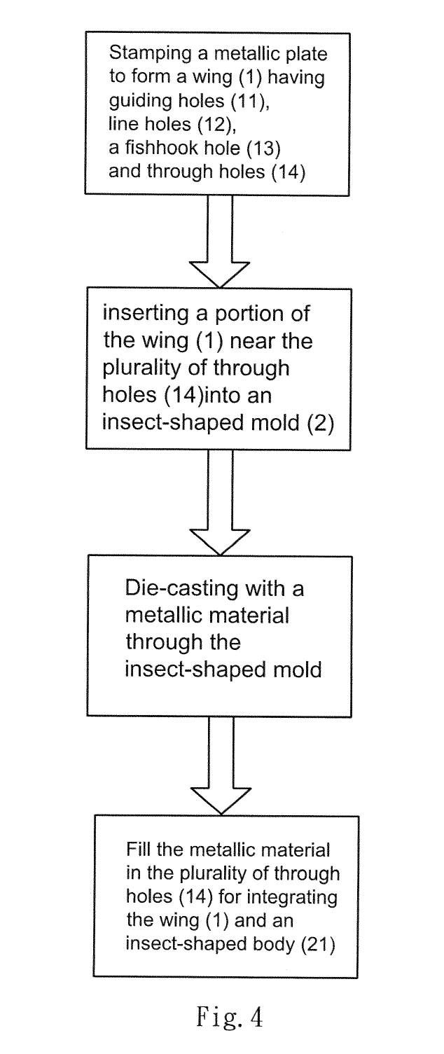

Referring to FIG. 4, a method for manufacturing an insect-shaped fake bait comprising the following steps of:

(a) stamping a flexible metallic plate to form a wing 1 having a plurality of guiding holes 11, a plurality of line holes 12, a fishhook hole 13, and a plurality of through holes 14;

(b) inserting a portion of the wing 1 near the plurality of through holes 14 into an insect-shaped mold 2; and

(c) die-casting with a metallic material to fill the metallic material in the plurality of through holes 14 for integrating the wing 1 and an insect-shaped body 21.

The shape of the insect corresponds to the shape of the wing, which may be designed in different shapes.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An insect-shaped fake bait structure, comprising:
a wing made of a metallic plate, having a plurality of guiding holes, a plurality of line holes, a fishhook hole and a plurality of through holes, the plurality of through holes being inserted into an insect-shaped mold for filling a material therein, the fishhook hole being adapted for a fishhook to be inserted therethrough; and
an insect-shaped body, a portion of the wing about near the plurality of through holes being formed by die casting with a metallic material through the insect-shaped mold to form the insect-shaped body, the wing being integrated with the insect-shaped body by filling the material in the plurality of through holes, the insect-shaped body being formed with a notch, the fishhook hole of the wing being located in the notch for positioning a fishhook.

2. The insect-shaped fake bait structure as claimed in claim 1, wherein the wing is made of a flexible metallic plate for providing a swing effect in a turbulent flow.

3. The insect-shaped fake bait structure as claimed in claim 2, wherein the flexible metallic plate is a copper plate.

4. The insect-shaped fake bait structure as claimed in claim 1, wherein the insect-shaped body has a specific gravity greater than that of sea water or lake water for facilitating the insect-shaped fake bait to sink in the sea water or lake water.

5. The insect-shaped fake bait structure as claimed in claim 4, wherein the insect-shaped body is made of a lead material and formed by die-casting.

6. A method for shaping an insect-shaped fake bait, comprising the following steps of:
(a) stamping a flexible metallic plate to form a wing having a plurality of guiding holes, a plurality of line holes, a fishhook hole, and a plurality of through holes;
(b) inserting a portion of the wing near the plurality of through holes into an insect-shaped mold; and
(c) die-casting with a metallic material to fill the metallic material in the plurality of through holes for integrating the wing and an insect-shaped body.

7. The method for shaping an insect-shaped fake bait as claimed in claim 6, wherein the wing is made of a flexible metallic plate for providing a swing effect in a turbulent flow.

8. The method for shaping an insect-shaped fake bait as claimed in claim 7, wherein the flexible metallic plate is a copper plate.

9. The method for shaping an insect-shaped fake bait as claimed in claim 6, wherein the insect-shaped body has a specific gravity greater than that of sea water or lake water for facilitating the insect-shaped fake bait to sink in the sea water or lake water.

10. The method for shaping an insect-shaped fake bait as claimed in claim 9, wherein the insect-shaped body is made of a lead material and formed by die-casting.
